(19) United States
(12) Patent Application Publication
(10) Pub. No.: US 2010/0206124 A1
(43) Pub. Date: Aug. 19, 2010

(54) HANDLEBAR ARMREST

(76) Inventor: STEVE J. FERRUSI, ANTIOCH, TN (US)

Correspondence Address: DYKAS, SHAVER & NIPPER, LLP, P.O. BOX 877, BOISE, ID, 83701-0877, US

(21) Appl. No.: 12/693,603

(22) Filed: Jan. 26, 2010

Related U.S. Application Data
(60) Provisional application No. 61/207,591, filed on Feb. 17, 2009.

(51) Int. Cl. B62K 21/12

(52) U.S. Cl. 74/551.8

(57) ABSTRACT

An armrest for use on bicycle type handlebars of stationary bikes and bicycles used as indoor trainers. The device allows operator to rest forearms on padded and absorbent top surface for increased comfort and free use of hands and fingers while exercising. Armrest is shaped to allow placement of a laptop computer type device where hands rest. Armrest is positioned on handlebars with securing straps securing armrest by pulling down to handlebar by way of fore and aft location of straps.

### PRIORITY/CROSS-REFERENCE TO RELATED APPLICATIONS

This application claims the priority date of the provisional application entitled INFLATABLE REST PAD FOR BIKE HANDLES filed on Feb. 9, 2009, with application Ser. No. 61/207,591, the disclosure of which is incorporated by reference.

### FIELD OF THE INVENTION

The invention relates to exercise devices and more particularly to bicycle type exercise devices with a bicycle handlebar type handgrip.

### BACKGROUND OF THE INVENTION

There are many bicycling type exercise devices, such as stationary exercise bikes. Many people also set up their bicycle on a training stand so that it becomes a stationary bicycle. For serious cyclists, this allows them to ride their regular bicycle and do their training with the exact geometry that they will be riding with in better weather. For bicycles set up on a training stand, the rear wheel is allowed to spin and may have some type of resistance device attached to it, such as a variably resistant magnet, or a fan, or other device which is powered by contact with the rear wheel. Each of these devices are used extensively by people exercising indoors, at times when the weather outdoors is not conducive to riding a bicycle.

Many bicycles are tiresome to ride indoors for a long period of time because they are configured so the rider is leaning forward and supporting part of the weight of his upper body with his hands in contact with the handle bar of the bike. This can be true even with stationary bicycles. This kind of support causes strain on the bike rider's hands, wrists, arms, shoulders, and neck. If this position were more comfortable, the bike rider would exercise longer and be more comfortable when exercising on his bicycle.

Another problem with indoor cycling is that it can be boring. Anything that can add interest to the indoor cycling experience can result in the rider getting a better and longer workout, and being less bored while doing it. This experience will commonly cause an increase in the frequency which persons will use indoor exercise equipment

One way to alleviate the boredom of indoor cycling is to simply watch TV. This does not solve all of the problems for all riders, because TV programs are interrupted by commercials, and with as many channels as are available, the rider may spend a lot of time switching channels at commercials, or looking for a different channel to watch. This distraction cuts down on the duration of efficient cycling and reduces the exercise value of the indoor cycling.

If something could be provided that would help alleviate boredom, add more comfort to the indoor bike riding experience, allow a rider to ride longer, and at the same time, cause the biker to ride more often, it would improve the benefits of indoor cycling even more. The invention presents a problem solving way for persons interested in multitasking while exercising. Typically, this person will use the invention with indoor exercise cycles while positioning a laptop type computer within comfortable reach to type while pedaling. With the desk-like feature, a typical user may use video game controllers, mobile phones, read books, fold clothes, type comfortably, or process office type documents. The equipment would rest on the handlebars as a desk with the ability to support rider weight on elbows and forearms with desk surface positioned where hands would reach a laptop type device with ease while supporting up to, but not limited to 50 lbs.

### SUMMARY OF THE INVENTION

The invention is a handlebar armrest for use with bicycle type handlebars. In one embodiment it can serve to replace the entire handlebar, or can also fit over the top of an existing handlebar. Such handlebars may be present on a bicycle being used as an exercise bike, or on various kinds of exercise devices which are similar in configuration to a bicycle. Bicycles of this type may include road bikes, which are set up on rollers for temporary use as an indoor exercise machine and other types of bikes, such as BMX, mountain bikes or cruiser bikes which may be set up for use as a stationary bicycle. Similarly, the handlebar armrest of the invention can be pressed over most stationary exercise bicycles or can be easily modified to press over many types of stationary bicycles.

Such bicycles usually have a stem, which is the upright piece to which the handlebar is attached, creating a “T” pattern. Additionally, often an “H” pattern exists when bars are added to the ends of the handlebar. These are more common on stationary bicycle handlebars. The device of the invention includes an armrest body which has a top surface and a bottom surface, a front side and a rear side, and a left side and a right side. The top surface of the armrest body is configured for support of a bike rider's forearms with a planer area to support a laptop device extended in front of forearm area.

By supporting the user's forearm, the armrest body allows the user to increase the variety of places to transfer upper body weight while sitting. This will cause the rider to be more comfortable. The armrest body will allow the rider to place the upper body weight on forearms and elbows, allowing rest to the hands and wrist. With body weight off hands and onto elbows, the rider's hands become available for multitasking options. By incorporating some conveniences into the armrest body, the user can relieve the boredom of indoor cycling, and have some creature comforts. These comforts include drinking utensils, which can be mounted in depressions in the surface of the armrest body, bags to hold items such as a phone, video controller, etc. The armrest body will also provide a laptop tray on which a user's laptop can be placed. The laptop tray is configured in one embodiment to be an integral part of the armrest. In another embodiment, the laptop tray can be removable and attachable when the user chooses to use it. In either configuration, a laptop tray is configured to position the keyboard of the laptop within easy reach of the user's fingers, as his forearms are placed on the top surface of the armrest body.

The bottom surface of the armrest body defines a choice of patterns, T or H, or other patterns which create securing and positioning slots to be placed over the handlebars and pressed into place. The slot thus encircles three sides of the handlebars. The device also includes a slot for insertion of the handlebar stem. The handle bar stem slot can extend from the front side to the back side as a groove similar to the handlebar slot. It can also be shorter because many stems of bicycle type handlebars are short and would not need such a long slot. Like the handlebar slot, the stem slot encircles the handlebar stem and allows the armrest body to fit over the top of the handlebars. In one embodiment, the armrest of the invention may be bolted to the existing handlebar.

A drink container, as mentioned above, can be placed in a recess which is defined in the top surface of the armrest body which is shaped to support the lower end of the drink container. Also, a commonly available cycling computer with a display of distance, time, speed, cadence, etc, may be positioned on the top surface of the armrest. The armrest top surface may have depressions which allow for the comfortable placement of the user's forearms in the depressions. These depressions may be padded or be lined with a resilient surface which provides cushioning. The entire surface of the armrest may be covered by an absorbent covering, which provides comfort for the user, and which absorbs sweat, and for this reason is removable and washable. The armrest of the invention attaches to the handlebars by one or more straps. A typical configuration of straps is one in which the straps are embedded in the armrest body, in the front and rear of the armrest and extend downward to wrap around parts of the bicycle frame. This creates a three point mounting system where the handle bar slot provides proper positioning to a variety of riders, with straps pulling in a downward action on armrest, suspending it immoveable over the fixed handle bar region. The straps include a device for tightening them, and may include a resilient device for applying additional tension as the armrest is in use.

The forearm depressions in the top surface of the device are generally angled, with the depressions being closer at the front end of the armrest body. This is consistent with the anatomy of a typical user, in which the elbows would be placed wider than the hands on such a resting device. The armrest body may be made of a number of different types of materials, or combinations of materials. One successful embodiment of the invention is with an eps (expanded polystyrene) or pe (polyethylene) material. On this polystyrene or Styrofoam body, padded armrest inserts may be placed, as well as an absorbent cover. Another configuration of the device is in which the device is made of a foam material. When constructed of foam, an inner stiffening panel may be present to provide rigidity to the armrest body. When made of different layers of foam, the top surface of the device may be covered by closed cell foam, or one with a smooth surface which does not absorb moisture, the side surface may have a thin, hard shell plastic coating to provide color options over foam or an inflatable core and the bottom surface may be covered by a softer rubber surface which provides a gripping power for the armrest to be secure over the handlebars.

The purpose of the Abstract is to enable the public, and especially the scientists, engineers, and practitioners in the art who are not familiar with patent or legal terms or phraseology, to determine quickly from a cursory inspection, the nature and essence of the technical disclosure of the application. The Abstract is neither intended to define the invention of the application, which is measured by the claims, nor is it intended to be limiting as to the scope of the invention in any way.

Still other features and advantages of the claimed invention will become readily apparent to those skilled in this art from the following detailed description describing preferred embodiments of the invention, simply by way of illustration of the best mode contemplated by carrying out my invention. As will be realized, the invention is capable of modification in various obvious respects all without departing from the invention. Accordingly, the drawings and description of the preferred embodiments are to be regarded as illustrative in nature, and not as restrictive in nature.

### BRIEF DESCRIPTION OF THE DRAWINGS

FIG. 1 is a perspective view of the armrest of the invention.

FIG. 2 is perspective view of the underside of the armrest of the invention.

FIG. 3 is a side view of the armrest of the invention with a laptop shelf attached to the armrest, and with a rider on the bicycle.

FIG. 4 is a perspective view of the armrest of the invention on a stationary bicycle with a rider.

FIG. 5 is a perspective view showing details of the laptop shelf mounted on the armrest.

### DESCRIPTION OF THE PREFERRED EMBODIMENTS

While the invention is susceptible of various modifications and alternative constructions, certain illustrated embodiments thereof have been shown in the drawings and will be described below in detail. It should be understood, however, that there is no intention to limit the invention to the specific form disclosed, but, on the contrary, the invention is to cover all modifications, alternative constructions, and equivalents falling within the spirit and scope of the invention as defined in the claims.

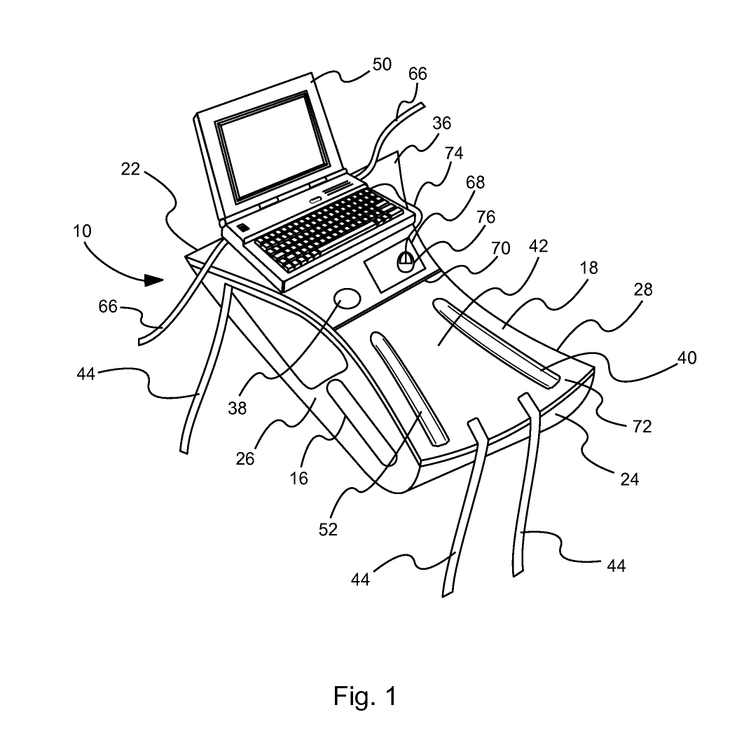

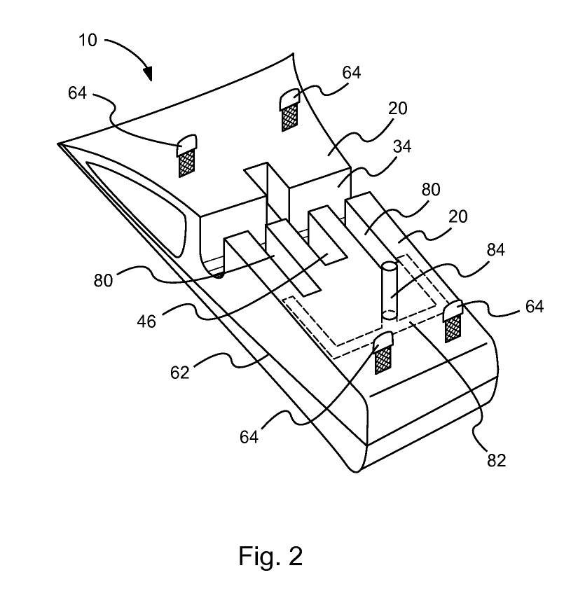

FIGS. 1 through 5 show the armrest of the invention. FIG. 1 shows the handlebar armrest of the invention as seen from above. The armrest of the invention is designated as 10 in the photos. Shown in FIG. 1 is the armrest, with the armrest body designated as 16, a top surface 18, a front side 22, a rear side 24, a left side 26, and a right side 28. Not shown in FIG. 1 but better shown in FIG. 2 is the bottom surface 20. Also shown in FIG. 1 is a drink container recess 38 in which a water bottle or other drink container may be placed. Shown in FIG. 1 is an optional trackball 68, with USB cable 74. Raised edge contours 72 may be present for a more comfortable fit and for resistance to arms sliding apart and are shown in FIG. 1. A ridge 70 is shown for supporting the laptop 50, and this ridge may be positioned as shown or may be completely around the laptop area. Forearm depressions 40 are present, which are generally recessed concave regions which are in the general shape of a bike rider's forearms. They are positioned so that a bike rider may place his forearms in the forearm depressions 40, in order to achieve a more restful posture, to resist the sliding apart of arms, and in order to free his hands for use of other devices on top of the handlebar armrest 10. Resilient inserts 52 may be secured in said forearm depressions for a more comfortable surface. Vents (not shown) may be present in the top surface laptop tray area of the device.

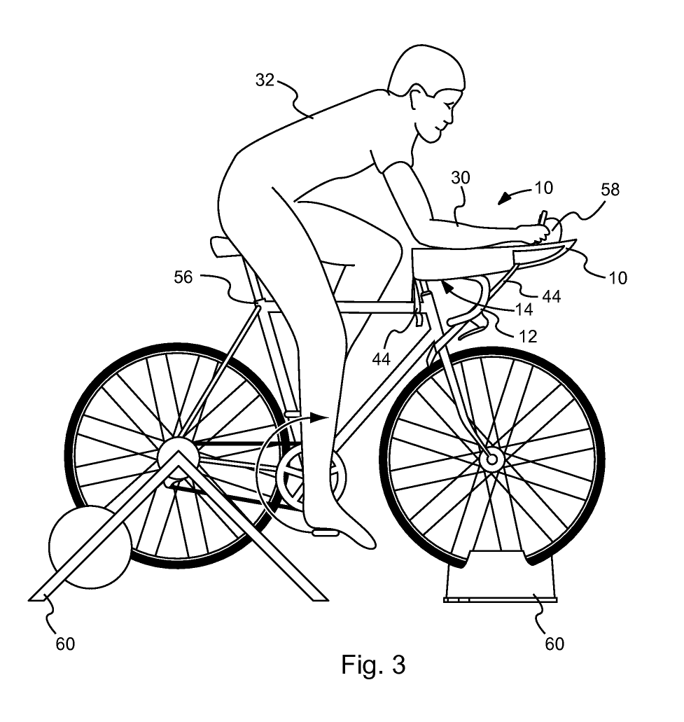

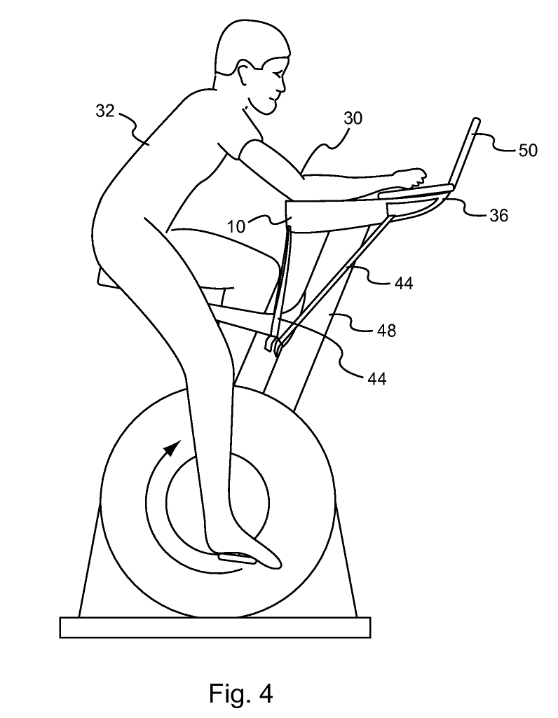

To provide for use of other devices, a laptop shelf 36 is provided to which a laptop 50 may be attached. The laptop tray can be adjustable as well as removable. The tray can slide in or out from the elbow rest area, at the user's discretion. Straps 66 illustrate one way that the laptop 50 may be secured to the device. Alternative to a laptop, a video controller module can be conveniently placed on the laptop shelf 36, for use by the rider while he is cycling. The capability to use both of these devices helps alleviate the boredom of indoor cycling, and encourages the rider to use an indoor cycling opportunity more often and for longer duration. Being able to lean down and rest rider's forearms takes the strain off of his hands, wrists, and shoulders, and allows for more comfortable cycling. Also having ones hands free in this position allows the rider to use a laptop, video controller, text, and to hold a book. The handlebar armrest of the invention includes various attachment straps 44, with which the device is secured over the handlebars of a bicycle type exercise machine. Such an exercise device can be a bicycle mounted on a trainer, as shown in FIG. 3, or it can be the armrest of the invention mounted on a stationary exercise device as shown in FIG. 4, over the handlebars of the exercise machine. The armrest can also be bolted to the stationary bike frame or handlebars, or press fitted over the handlebars and strap mounted to the frame. Another embodiment shown in FIG. 2 is one with one or more handlebar type tubes 82 embedded in a material such as EPS foam, which provide support and a mounting location when armrest is to replace existing exercise device handlebar. This embodiment provides a location for embedded support tubes 82 to exit eps foam 20 in a fashion that can be used as a mounting surface 84 such as a typical handlebar mounting to stem.

The handlebar armrest 10 of the invention can be made of a number of different materials, such as expanded polystyrene foam, open or closed cell foam, or it may be inflatable. A reason to choose an inflatable would be the compact size for shelf space in a retail environment. Additionally, inflatable construction would allow a wider variety of press mounting tolerances. In one version, the armrest body has a stiffening internal member made of more rigid material such as plastic, over which is placed a layer of foam. This foam top surface 18 is contoured to create a shape consistent in FIG. 1. The top surface 18 of the invention will typically be made of a non-absorbent material, such as closed cell foam, or many other types of non-absorbent materials. The armrest body 16 will typically be covered by an absorbent covering 42 which is provided to absorb the sweat of a user. The absorbent covering 42 would be removable and washable and replaceable.

The forearm depressions 40 can also be lined with a resilient insert to provide more padding to the rider's forearms.

Shown in FIG. 2 is the bottom surface 20 of the handlebar armrest 10 of the invention. Shown in FIG. 2 is the handlebar slot 34, and the stem slot 46. Both of these are a form of positioning slots. These slots are provided to allow the armrest of the invention to fit over the handlebars of a bicycle or exercise bike and prevent sliding or movement and to prevent twisting and to provide a position for mounting the armrest. FIG. 2 shows an inner core 62, which may be plastic or other similar material, which is sandwiched between layers of softer or more flexible foam material. The device may also have inflatable bladders located on the bottom surface of FIG. 2, 20, which allow the armrest to have air added for increased stiffness and hold or air may be decreased for a softer rest area. FIG. 2 shows secure strap mount D rings 64 which display locations for securing strap 44 of FIG. 1 to suspend armrest over handle bar feature of both bicycles mounted in a trainer or stationary exercise device.

FIG. 2 also shows positioning slots 80, which are alternatives to the handlebar and stem slots, and some versions may utilize any or all of these slots depending on the configuration of the bike to be fitted with the armrest. Also shown in FIG. 2 is an embedded steel frame 82 with a mounting post 84, with which the armrest 10 may replace a bicycle or exercise bike handlebar.

FIG. 3 shows a rider 32 on a bicycle 56 with the handlebar armrest 10 of the invention pressed over the handlebars 12 of the bicycle, with the bicycle 56 mounted on a training stand 60. The armrest 10 is attached to the frame of the bicycle by attachment straps 44 which attach to the top tube and the head tube of the bicycle. An adjustable strap in the front can be looped around the front wheel or fork. An adjustable strap on the rear of the device, attached to the bottom of armrest with secured “D” ring 62 on one side loops down and under exercise equipment frame and back up to secured “D” ring 64, thus suspending the device over slots 34 and 80 on the underside of the armrest 10. This increases the security and stability of the armrest on any type of bike or exercise machine to which it is attached. Even if only one point on the armrest touches the bike frame, the fore and aft straps 44 act like guy lines on a tent to secure and stabilize the armrest 10. The portion of the bicycle to which the handlebars 12 (FIG. 3) are attached is the stem 14 which is inserted into the stem slot 46 of the invention, but which is not visible in FIG. 3. In FIG. 3, a video controller 58 is shown which is usable by the rider since his body weight is supported by his forearms 30.

Shown in FIG. 4 is the armrest of the invention 10 mounted on an exercise bike 48. It is attached by attachment straps 44 and is shown with a laptop 50 in use on the laptop shelf 36.

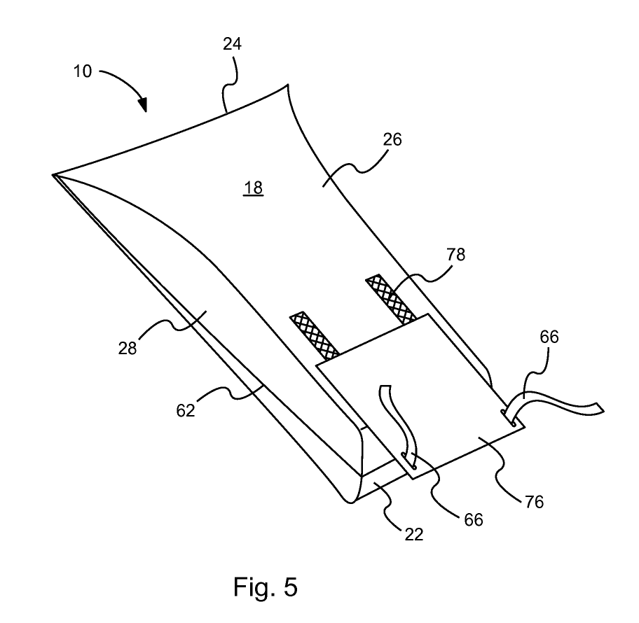

FIG. 5 shows the armrest 10 of the invention with details of the adjustable laptop tray 76. This includes hook and loop tray fasteners 78 attached to the top surface 18, by which the tray 76 is attached, using corresponding hook and loop fasteners on the underside of the tray 76. Laptop straps 66 are available for securing a laptop on the tray.

While there is shown and described the present preferred embodiment of the invention, it is to be distinctly understood that this invention is not limited thereto but may be variously embodied to practice within the scope of the following claims. From the foregoing description, it will be apparent that various changes may be made without departing from the spirit and scope of the invention as defined by the following claims.

What is claimed is:

1. An armrest pad for use with an exercise device with bicycle type exercise machines, comprising:
an armrest body with a top surface and a bottom surface, and with a front side, a rear side, a left side, and a right side, with said armrest configured for support of a bike rider's forearms in a position above a handlebar region;
a frame structure with a mounting post and an embedded frame in said armrest body, for attachment to said bicycle type exercise machine.

2. The handlebar armrest of claim 1 which further comprises a slotted configuration on said bottom surface which provides positioning and stability to said armrest when placed on top of said bicycle type handlebars.

3. The handlebar armrest of claim 1 which further comprises a securing and stabilizing system of adjustable straps pulling fore and aft to pull said armrest device down to said handlebar.

4. The handlebar armrest of claim 1 which further comprises a removable laptop shelf, configured to support a laptop in front of said bicycle type handlebars.

5. The handlebar armrest of claim 1 which further comprises an integral laptop shelf configured to support a laptop in front of said bicycle type handlebars.

6. The handlebar armrest of claim 1 which further comprises a drink container recess defined in said top surface configured to hold a drink container.

7. The handlebar armrest of claim 1 which further includes forearm depressions spaced on either side of a midline of said armrest, and angled at a front end toward said midline.

8. The handlebar armrest of claim 1 in which said forearm depressions further comprise padded surfaces in said forearm depressions.

9. The handlebar armrest of claim 1 which further includes a padded covering of said top surface.

10. The handlebar armrest of claim 1 which further comprises an absorbent covering for said top surface.

11. The handlebar armrest of claim 1 which further includes gripping posts for hands.

12. The handlebar armrest of claim 1 which further includes a removable storage bag which mounts with hook and loop fastening.

13. The handlebar armrest of claim 1 which further includes openings in design for storage.

14. The handlebar armrest of claim 1 which further includes raised edge and straps to secure laptop to device.

15. The handlebar armrest of claim 1 which further includes a depression in design to allow for a commercially available track ball computer pointing device to sit securely.

16. The handlebar armrest of claim 1 in which said armrest attaches to a bicycle type seat post by said attachment straps.
